(19) United States
(12) Patent Application Publication
(10) Pub. No.: US 2021/0150447 A1
(43) Pub. Date: May 20, 2021

(54) SYSTEM AND METHOD FOR EFFICIENT RETENTION OF TEMPORARY SERVICES

(71) Applicant: Band of Hands, Inc., San Diego, CA (US)

(72) Inventor: Aziz Badra, El Cajon, CA (US)

(21) Appl. No.: 17/099,396

(22) Filed: Nov. 16, 2020

Related U.S. Application Data
(60) Provisional application No. 62/935,959, filed on Nov. 15, 2019.

(51) Int. Cl. G06Q 10/06; G06Q 10/10; G06Q 40/00

(52) U.S. Cl. CPC G06Q 10/063112; G06Q 50/01; G06Q 40/125; G06Q 10/1053

(57) ABSTRACT

The disclosure is directed towards a system and method for efficiently sourcing and recruiting temporary workers and connecting those individuals with companies looking to hire those temporary workers as well as managing the workforce.

### CROSS-REFERENCE TO RELATED APPLICATIONS

This application claims the benefit of U.S. Provisional Patent Application No. 62/935,959 filed Nov. 15, 2019, which is hereby incorporated by reference herein in its entirety, including but not limited to those portions that specifically appear hereinafter, the incorporation by reference being made with the following exception: In the event that any portion of the above-referenced provisional application is inconsistent with this application, this application supersedes said above-referenced provisional application.

### STATEMENT REGARDING FEDERALLY SPONSORED RESEARCH AND DEVELOPMENT

Not Applicable.

### BACKGROUND

As will be understood by an examination of the following specification, the present disclosure is particularly directed towards a system and method for efficiently sourcing and recruiting temporary workers and connecting those individuals with parties seeking to hire those temporary workers, as well as managing the workforce. The present disclosure may be implemented on a platform with services accessible via website, such as on the Windows® operating system, as well as on the iOS™, Android®, and other, operating systems and applications. The technology creates a complete system without the need for regular human direction. Before a detailed description of the present disclosure is provided, a particularized explanation of the available industry will be provided next so that the advantages and benefits of the present disclosure can be fully appreciated.

The temporary staffing industry has been virtually unchanged for over one hundred years. The estimated market size for the staffing or temporary worker companies in the United States is approximately 200 billion dollars annually, while globally the estimate is over 400 dollars billion. The staffing industry consists of everything from local mom-and-pop operations to publicly traded companies. The large publicly traded companies are often franchised across the United States, but whatever the size, staffing firms typically operate in local or regional marketplaces in brick and mortar offices. With a few exceptions, staffing firms generally source talent from local markets to fill positions for businesses in those same markets. The few exceptions involve firms working closely with affiliates or other franchisees in other markets.

The general model used by staffing firms throughout the world involves a business (client) contacting the staffing company and requesting a particular type of skills or worker, whether a receptionist, cook, software engineer, etc. The staffing company sends out a contract and when a Dunn & Bradstreet report on the client clears and the client executes the agreement, the staffing company begins recruiting efforts to find the individual with the skills that the client is seeking.

When a worker is selected by the client company, the staffing company ensures that all of the necessary documentation is completed (such as the U.S. Internal Revenue Service (IRS) W-2 form) and makes the worker an employee of the staffing company. The staffing company then dispatches the worker to provide services for the client. Typically the staffing company charges the client a mark up in the range of 40% to 100% for the services of the employee. During the time of temporary services, the worker remains an employee of the staffing company. When the time of temporary employment is over, the worker remains an employee of the staffing company, but ceases to provide services for the client and can be dispatched to additional clients if eligible.

In the event that the client desires to hire the worker on a permanent basis, the client typically has to pay the staffing firm approximately 20% to 30% of the employee's annual salary to buyout their contract. Typically, the client and the worker sign contracts with the staffing company which require the buyout if the client hires the individual away from the staffing company.

A staffing company may operate on a number of different types of business models in addition to the method described above. Two main types of operation by a staffing company are pay-rolling and recruiting, as described next.

The pay-rolling model is a relationship between the client and the staffing company where the client has identified a potential worker and simply uses the staffing company to payroll that worker. The worker becomes an employee of the staffing company, but provides services directly to the client. The rates for pay-rolling are typically lower than if the staffing company recruited the worker as less effort is required by the staffing company in order to locate the worker. The staffing company is simply responsible for paying the worker and handling the various details. Typically, rates for pay-rolling range from 20% to 30% of the individual's salary. These rates include payroll taxes, unemployment taxes, state and federal taxes, on-boarding ad, off-boarding costs, and the staffing company's profit.

The recruiting model is the where the hiring client needs a worker but does not have anyone in mind, so the staffing company makes the effort to recruit and find the qualified person for the hiring client. Normal recruiting rates are significantly higher than with pay-rolling, often ranging from 40%-100% of the employee's salary, depending on the industry, the job description, the difficulty finding a candidate, and the worker's compensation code of the job the worker is expected to perform. Typically, the staffing company begins searching for an individual once a request is made by a company, and takes a very expensive, hands-on process, where the staffing company acts as an intermediary and connector between the client and the potential employee.

The staffing company goes through the hiring process, typically having potential employees go through an application and interview process where the staffing company performs personal interviews and attempts to find appropriate employees. Then, when there is an opportunity, employees are contacted by the staffing company and the company sends the worker that it believes is best suited to the position described by the client. The client typically has little say about who is sent to work, especially when a request is made to fill a position quickly. Even when a request is made to quickly fill a position, it may take 24 to 48 hours for the staffing company to find a worker for the client. This process is expensive and time-consuming. When the client is a new client of the staffing company it can be more expensive and time consuming as the staffing company typically has a similar interview and background check process to clear new clients.

The individuals who are employed by a staffing company are the workers. The workers are typically paid by the staffing company, which then invoices the client for the hours that the worker has worked. The terms of service contract which a worker typically signs outlines that the worker may not seek or accept employment for up to one year with any particular client unless a roll over fee is paid by the client. Clients typically sign similar contracts for the services they are asking the staffing company to provide. These contracts require the client to agree to the roll over fee in the event they choose to permanently hire an individual worker for the client business. The contracts include a buyout clause with the details of the fees and requirements for the client to hire the staffing company's employee.

Typically the buyout clause requires a payment from 20% to 30% of the individual worker's annual salary. This fee is paid directly to the staffing company in order to release that worker from their employee contract with the company. The contract with the staffing company gives the staffing company complete control over the relationship between the hiring client and the employee. This is necessary because the typical staffing company makes its profit on the markup between from the salary paid to the employee and the amount paid by the client to the staffing company.

In contrast to state of the industry described above, the present disclosure provides a national platform for sourcing and recruiting individuals for work, which, through centralization and automation, facilitates the hiring of temporary employees to clients at near cost pricing. The features and advantages of the present disclosure will be set forth in the description that follows, and in part will be apparent from the description, or may be learned by the practice of the disclosure without undue experimentation. The features and advantages of the disclosure may be realized and obtained by means of the practices and combinations particularly pointed out herein.

### SUMMARY OF THE DISCLOSURE

A purpose of the instant disclosure is to create a system and method which is a national platform for sourcing and recruiting individuals for temporary work. The system includes full native iOS and Android applications along with a complete website, such as on a platform using the Windows® operating system, and the services can be accessed on all such, and other, platforms.

### BRIEF DESCRIPTION OF THE DRAWINGS

FIG. 1 shows the operation of a typical temporary staffing service.

FIG. 2 shows the operation of a method for the efficient retention of temporary services as shown in one embodiment of the instant disclosure, showing the operation of the company operating the system.

FIG. 3 shows one example of a pricing model of the instant disclosure, showing the cash flow of the instant disclosure in the subscription fee rather than in large markups on employee salaries.

FIG. 4 shows the operation of one embodiment of a method for the efficient retention of temporary services from the side of the temporary employees.

FIG. 5 shows one embodiment of a system for the efficient retention of temporary services, showing the client side and employee side and functions of each.

FIG. 6 shows one embodiment of a system for the efficient retention of temporary services, showing the client side and employee sides of the platform as well as the interfaces with the staffing company and finance company.

### DETAILED DESCRIPTION

For the purposes of promoting an understanding of the principles in accordance with this disclosure, reference will now be made to illustrative embodiments of the invention. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before the devices, systems, processes and methods will be disclosed and described, it is to be understood that this disclosure is not limited to the particular configurations, process steps, and materials disclosed herein, as such configurations, process steps, and materials may vary somewhat. It is also to be understood that the terminology employed herein is used for the purpose of describing particular illustrative embodiments only and is not intended to be limiting since the scope of the disclosure will be limited only by the appended claims and equivalents thereof.

In describing and claiming the subject matter of the disclosure, the following terminology will be used in accordance with the definitions set out below.

It must be noted that, as used in this specification and the appended claims, the singular forms “a”, “an”, and “the” include plural referents unless the context clearly dictates otherwise. As used herein, the terms “comprising,” “including,” “containing,” “characterized by,” “having” and grammatical equivalents thereof are inclusive or open-ended terms that do not exclude additional, unrecited elements or method steps.

The system and method disclosed herein more effectively and efficiently connects temporary workers to the companies looking to hire them, allowing a staffing company to charge rates similar to pay-rolling when recruiting employees. In addition, since the service becomes the product rather than the workers, the instant disclosure allows the staffing company to eliminate buyout clauses entirely. The system and method create a nationwide marketplace which allows the staffing company to make money through a subscription service. This a radical improvement over the status quo for temporary staffing services currently being provided on the market.

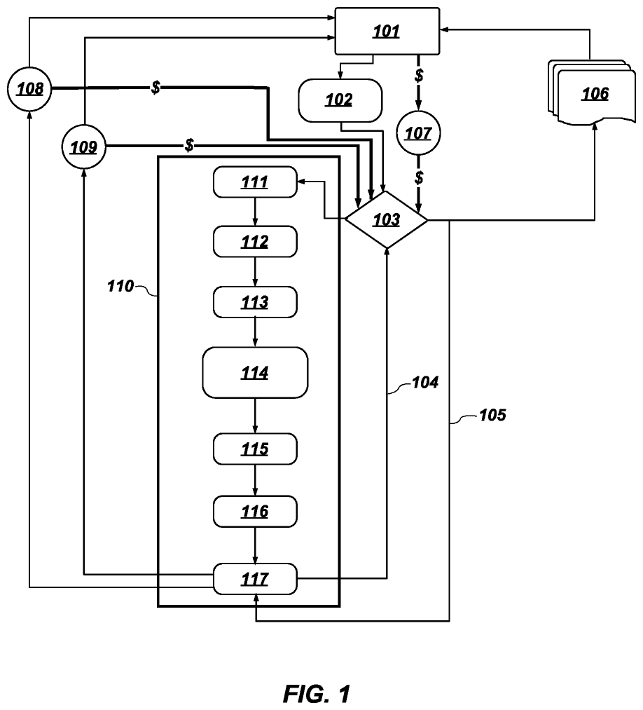

The system and method disclosed herein will be disclosed as compared to the typical staffing services business model shown in FIG. 1. In a typical temporary staffing industry a client company 101 signs an exclusive contract 102 with the staffing company 103. The staffing company 103 goes through the process 110 of obtaining temporary employees for the client company 101. In a typical staffing company, that process includes posting jobs 111, screening candidates 112, and choosing the top 3-5 candidates for the company 113. At this point, the client company may choose an applicant from the top 3-5 selected by the staffing company and scheduling an interview 114. After conducting an interview process, the client company selects a candidate 115. It should be noted that the staffing company owns all applications and resumes, and generally presents only top few candidates to the client company.

After the client chooses an applicant, the staffing company performs a final background check 116, and the applicant starts work 117. At this point, the applicant is an employee of the staffing company, and submits his/her hours to the staffing company 104, which pays the employee's salary 105. The staffing company 103 submits an invoice 106 to the client 101, marking up the charge by a percentage which provides general operating income for the staffing company. The invoicing of the client is generally by 30 day terms. For example, the staffing company may pay the employee fifteen dollars per hour, while charging the client company thirty dollars per hour. The payment 107 from the client to the staffing company is the first time the staffing company receives income under this model. The markup provides the staffing company with its operating income. This markup may be up to 100%, or more, markup of the pay given to the employee.

Another source of income for the typical staffing company is the payment of a roll over/buy out or a direct hire fee. If a client chooses to direct hire an applicant 108, rather than having the applicant work through the staffing company, a fee is charged to the client. This fee may be as large as 20% of the annual salary of the worker or typically up to US $12,000 in the United States. In other cases, a client may choose hire a temporary worker after the worker has been with them for a period of time 109. In this case, it is typical to charge a reduced, but still significant fee to the company desiring to hire the temporary employee. It should be noted that in the typical staffing company, the employees sign a contract which requires a company that wishes to hire them from the staffing company pay a significant buy-out fee, and the staffing company keeps possession of all applications and resumes, which it can use to fulfill future assignments. The client may not ever see the resumes and applications beyond the top few determined to be the best by the staffing company.

In contrast to the model represented in FIG. 1, applicant has developed a novel approach to solving the problem of temporary workers, which is a web-based centralized subscription model. The majority of staffing companies operate on a de-centralized model, meaning every locale has its own business, infrastructure and staff with complete overhead as other businesses. By utilizing a web-based centralized subscription model as disclosed herein, a staffing company can offer a subscription to a web-based platform as a service, eliminating many of the costs traditionally associated with a staffing service and providing a novel approach to temporary staffing where the main source of income for the staffing company is a subscription fee. The present disclosure set forth herein is novel in the staffing industry, and requires a novel approach to offer staffing services as a subscription-based web platform.

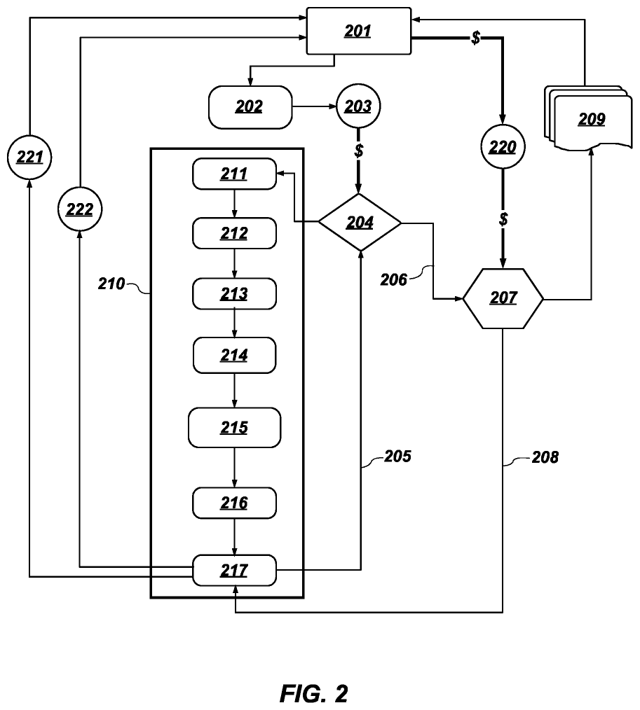

Applicant has developed a platform for sourcing and recruiting individuals for work. In one illustrative embodiment this platform is accessible via a website and via iOS and Android applications. This platform allows businesses to make postings searching for temporary workers. Every worker on the platform can then see the available temporary positions. In one illustrative embodiment, the platform includes an option which allows the workers to set a distance they are willing to travel using location-based services on their phone, and the platform then sorts the jobs based on proximity to the worker. FIG. 2 represents one illustrative embodiment of how a platform for sourcing and recruiting individuals for work operates with the client companies and the staffing company.

In the embodiment of FIG. 2, the client company 201 signs a membership agreement 202 and pays a monthly membership fee 203 to the staffing company 204. In one illustrative embodiment, the membership fee is the main source of income for the staffing company. The process for hiring 210 is different from the standard staffing company in that the client 201 posts a job 211 on the platform. Each individual worker on the platform can see the job posting made by the client company and may search the job postings made by various client companies through a search engine provided on the platform. In one embodiment, workers who are members of the platform may apply for jobs and be considered to fill those positions by the client companies. In one embodiment, the software from the platform may screen the candidates 212 and recommend the top 3-5 candidates to the client 213. In one illustrative embodiment, the staffing company may rank the top 3 candidates as “Recommended,” “2,” and “3,” respectively in order of recommendation. However, the client has access to information about all members of the platform who choose to apply to a given position, and subsequently chooses the applicant or applicants to interview.

In one representative embodiment, the client may schedule an interview 214 with a given worker. In one representative embodiment, the platform may provide a connection for the candidate and the client business to set up an interview and to privately video conference or call to perform an interview. Once the interview (if desired) is completed, the client selects an applicant to fill the temporary position 215. It will be noted that unlike a standard staffing company, in the instant disclosure, while the staffing company may recommend the top 3-5 applicants to the client, all the resumes and applications submitted for the particular jobs are provided to the client company, which may choose to interview an applicant other than the top 3-5 candidates provided by the staffing company. In another illustrative embodiment, the client company may choose to make a hiring decision based only upon the information provided by the staffing company on the available candidates. After an applicant is selected by the client, the staffing company may perform a final background check 216.

Still referring to FIG. 2, after an applicant is chosen, the employee begins work 217. The employee submits their hours 204 to the staffing company 203, which submits the hours 206 to a finance company 207. The finance company 207 pays the employee 208 and bills the client company 209, again generally in 30 day terms, though in other embodiments the client may be invoiced in terms of different period. In one illustrative embodiment, the finance company may be a third-party finance company that provides payroll services. In another illustrative embodiment, the finance company may be a division of the staffing company designated to specifically provide payroll services. In yet a further illustrative embodiment, the finance company charges only the standard employment cost, taxes, insurance, and similar charges to the client company without adding any profit, which provides a much smaller mark-up than in the case of a general temporary staffing company, which derives a major source of income from the mark-up. For example, an employee who is paid fifteen dollars per hour may cost the client only seventeen dollars and seventy cents (US $17.70) per hour in the United States using the system of the instant disclosure, instead of the up to thirty dollars per hour it may cost from a staffing company operating on the model set forth in FIG. 1. The client company pays the staffing company 220 for the employee's salary plus the much smaller mark up for taxes and other employment costs. In one illustrative embodiment of the instant disclosure, the only source of income for the staffing company is the monthly membership fee 203 paid by the client company.

Another illustrative embodiment of the instant disclosure involves the situation where a client wants to directly hire 221 or roll over 222 an employee and begin employing that employee directly rather than through the staffing company. In the standard staffing company model represented in FIG. 1, the employees are the resource the staffing company uses to make money, and as such the staffing company charges a large buyout fee to a company desiring to hire the employees directly. However, a company using the model of the instant disclosure, as represented in FIG. 2, has the monthly membership fees 203 as its main source of income. As such, a company using the instant disclosure can charge no additional fee to a client desiring to directly hire an employee.

One representative embodiment of a method for the efficient retention of temporary services advantageously provides a lower recruiting rate, with a mark up of only 19-28%, in contrast to the standard staffing model which has mark ups for recruiting of 45-100%. In accordance with the instant disclosure, a pay-roll rate would be a similar 19-28% markup, in contrast to the pay-roll rate for a standard staffing company may be in the neighborhood of 20-45%. Thus, a company utilizing the instant disclosure can charge lower rates because the company's main source of income is from the membership fees paid to access the employees of the staffing company. As such, the stated method for the efficient retention of temporary services can dispense with the usual yearly contract for both employees and client businesses, as well as eliminate expensive buyout clauses, in favor of a specific monthly or yearly fee for access to the employees of the company.

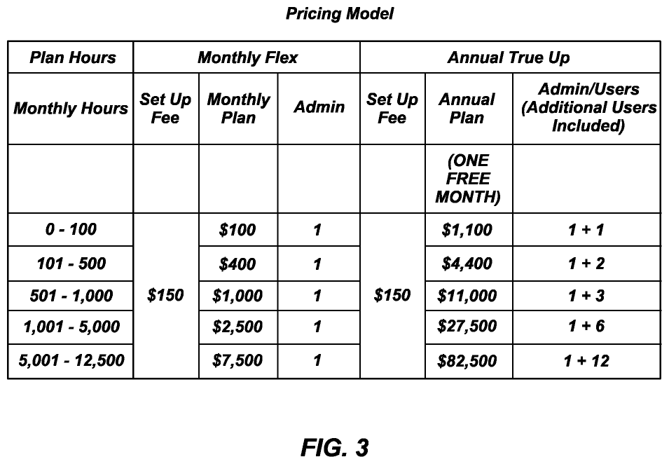

In one illustrative embodiment of the system for efficient retention of temporary services, the system is offered as a software as a service model, wherein the temporary staffing company offers a monthly plan with an option to prepay annually and receive a free month of service, for businesses. In one illustrative embodiment the service is free to join for individual workers. FIG. 3 shows a pricing model which is present in one embodiment of the instant disclosure. In this embodiment, there is a single set-up fee which is paid when the client business signs up for the services. In one illustrative embodiment, the subscribing client business gains access to benefits which may include, but are not necessarily limited to: pay-roll rates for recruited positions, no contracts, no buyout clause, free unlimited job postings, and an alumni program.

In one illustrative embodiment of the present disclosure, the platform has two sides, a recruiting side and a business side. The recruiting side allows potential workers to download the application and review available work opportunities. The business side allows businesses to sign up for the subscription service, post available position, receive applications from workers, and evaluate and choose the best candidate for the job. Both sides use only technology without involvement from staff at the temporary staffing agency. This allows a far less expensive sign up and recruitment process than that of the traditional temporary staffing industry, where there is typically a very hands-on approach. In the traditional staffing industry, the staffing company begins searching for an individual once a request is made and acts as the intermediary and connection between the requesting hiring client and the employee, whereas the instant disclosure allows the client company to examine a worker's credentials and choose which employee to request from the staffing company, allowing the client to hire an employee from the staffing company without paying an expensive buyout.

In one illustrative embodiment of the method, the client company pays a subscription fee based on the hours worked by temporary employees hired on the platform. A typical subscription plan for the client company will be based upon the number of hours temporary workers work for the client, but other subscription models may be conceived of which would be within the intent of this disclosure. As the staffing company may have a nationwide marketplace and a centralized model, the subscription fee serves as the main source of revenue, not the markup on the employees themselves. The staffing company provides the clients with a searchable list of available employees, and the client communicates directly with the potential employee. The platform allows clients to post information on job openings, as well as allowing employees to post information on their credentials and information about themselves. The clients themselves make the decision on which temporary worker works for them. The platform communicates the employees' credentials to the client companies, allowing them to make informed decisions about which temporary worker to hire.

In one illustrative embodiment, the client can view the potential workers' social media, resume, ratings and reviews, and any other information that the employee wants to convey to the potential hiring client. This allows the client to make the best decision in choosing the right candidate. In one illustrative embodiment, the platform has a system that allows client companies to rate potential workers and provide information on their experience with a particular worker. Similarly, another illustrative embodiment provides an opportunity for an employee to provide a rating on client companies with which they have worked.

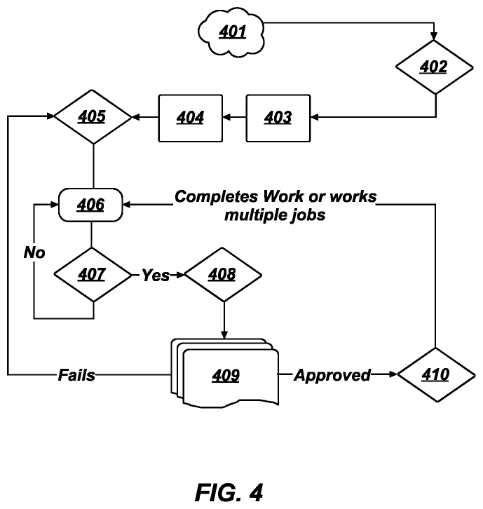

On the worker side, represented in FIG. 4, a worker may download an app 401 which is provided by the staffing company 402. The worker then signs up for the service and creates a username and password. The application prompts the user to submit personal information 403 relevant to employment and create a profile 404, which includes entering a resume, entering information about their skills, and providing any other pertinent information that the worker would like employers to read. This information is provided to the staffing company 405, and the worker can then search jobs 406. There is no contract required for the worker other than agreeing to the terms of service registered on the website. If the worker sees a job that the worker wants, they can apply 407 for the job from either the mobile app, or directly from the website of the staffing company.

Still referring to FIG. 4, once a worker submits an application for a job, the client company that posted the job is immediately notified. After applying for a job, the worker's profile is accessible to the client company, which can review the profile, LinkedIn® page, and resume of the workers that have applied for a job posted by the client company. The client company also has the option of requesting a video conference/interview with a worker via the staffing company's platform, which may take place on a variety of platforms, such as mobile devices and on the website itself. The client company may also choose to forego an interview and make a hiring decision solely based on an applicant's profile. If the client company 407 decides not to hire the worker, the worker can return to searching jobs 406. The worker may apply to many jobs simultaneously, and may even work more than one job simultaneously, if circumstances allow.

In one illustrative embodiment, each client company may create its own profile. This allows the workers to examine the profile of a client company before deciding whether to apply for a job posted by that particular client company. In another embodiment, a worker's profile may give a client company access to the worker's background checks, motor vehicle reports, social media accounts, and any other information about the worker which could be relevant to a client company's hiring that worker.

Continuing to refer to FIG. 4, once a client company decides to hire an applicant, the worker returns to the platform 408 and completes a detailed application for employment 409, if the worker has not already done so for previous jobs. This application which includes proving eligibility to work. In addition, any background screen required by the employer is performed. Typically these requirements are fulfilled with the first job the worker is offered. If these requirements are successfully met, then the worker may begin working for the client company 410. If the requirements are not successfully met, then the worker may have different solutions. In one illustrative embodiment, if the worker was able to prove eligibility to work but could not pass the background check, then the worker may return to searching for jobs that do not require a background check. If the worker could not prove eligibility to work, however, in one illustrative embodiment the worker may not longer be a part of the staffing company platform. Upon completing the temporary job, the worker may again search for another job. In one illustrative embodiment, the worker may continue to search for jobs while working at one job and may work at several jobs at once, if appropriate.

In one illustrative embodiment, workers are hired to the staffing company and may then work at multiple different employment opportunities posted by client companies on the platform. The workers receive checks for any and all jobs worked during the particular pay period, regardless of how many different locations or companies they may have worked with. In one illustrative embodiment, the required paperwork is provided to the worker by a separate company hired by the staffing company to handle pay-roll.

In one illustrative embodiment of the instant disclosure, there is a Master Subscription Agreement and Terms of Service that client companies agree to upon signing up. Once the client has completed a profile and including payment information for the subscription fees, a separate contract is provided from the payroll provider, which the client must complete for future job postings, such as IRS Form W-2 workers/employees in the United States. In one illustrative embodiment, the payroll provider is a separate company which provides payroll services between the client company and the temporary employee.

As the main product is the subscription and the information about employees, the staffing company need not bind workers or client companies to lengthy contracts, and need not have an expensive buyout clause. This allows for a far more flexible and workable relationship than the model represented in FIG. 1. This flexible relationship is made possible by the centralized nature of the model of the present disclosure and the use of technology. The system and method of the present disclosure transforms the product from the worker to the subscription, meaning that the company must have a greater reach which can only be accomplished with a centralized platform technology. This technology allows for a much smaller staff at the staffing agency, and allows the staffing company to survive on smaller margins and a different business model.

As with other businesses, the markup on the product is based on what the market will bear. Facilitating the hiring of temporary workers to clients at near cost pricing for a nominal monthly fee is a new approach to the problem present in the marketplace. In order to operate effectively this way, the staffing company must have national reach using technology with features such as location-based services. The current staffing industry model, represented in FIG. 1, is a de-centralized model, meaning every locale has its own business, infrastructure and staff with complete overhead as other businesses. The system and method of the instant disclosure creates a subscription model which is a web based centralized model. As such, the staffing company can cover an entire country, or other jurisdiction, without having to have physical presence in each local market. For a traditional staffing company using the prior model represented in FIG. 1 to change to this model would require that it decrease its margins dramatically and undergo a complete business model change, while incorporating new technology similar to the platform described in the instant invention, which the typical staffing company does not possess.

In one illustrative embodiment, the instant disclosure may comprise one or more computer servers, such as operating together as in a server farm. In one embodiment, the one or more servers comprise a non-transitory computer storage medium containing in memory a program which, when executed cause the system to perform the actions listed above. As will be appreciated by those skilled in the art, the configuration and programming of the one or more computer servers can be readily arrived at using the present disclosure to most efficiently carry out the system and method of this disclosure. Such programming will include the instructions stored in the computer medium which causes the computer medium to run and operate a system and method for the efficient retention of temporary services.

In one embodiment a system for facilitating the efficient hiring of temporary workers may include a fee based subscription service accessible to businesses for hiring temporary employees. In one embodiment this service is offered by a staffing company which charges a monthly fee for access to the service. In one embodiment this service may comprise instructions stored on an server or server farm as known in the art, comprising a web based platform accessible to other computers which can access the server, as known in the art. In one embodiment the service and platform may be accessible via a webpage maintained by the staffing company. In another embodiment, a user desiring to access the service may download an app through which they user may access the service. In another embodiment access may be through both an app and a website. While certain methods for accessing the platform have been recited, it will be appreciated that in some embodiments, other means for accessing the platform by a user may be devised and used without departing form the intent of the instant disclosure.

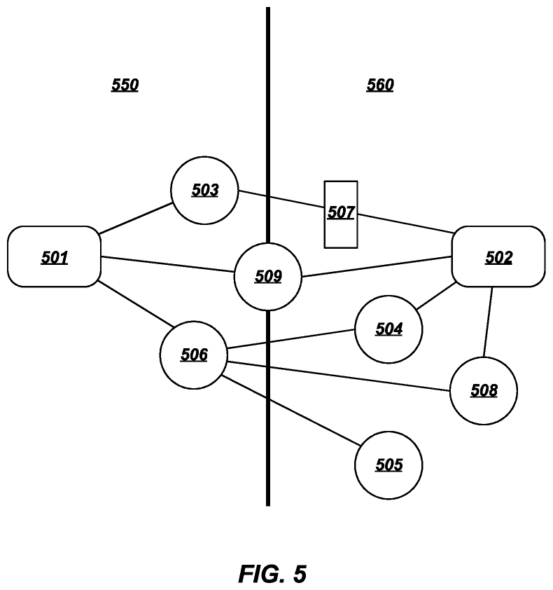

In one exemplary embodiment shown in FIG. 5, the platform is offered by staffing company and comprises an employee side 550 and a client side 560. In one embodiment, an individual searching for temporary employment 501 accesses the employee side 510, which includes a means for a potential temporary employee to create a unique profile 503. In one embodiment the user creates a unique login ID and password, and can create a profile 503 which may contain information relevant to employment, such as work experience, skills, education, and any other pertinent information which the potential temporary employee would like to enter for potential employers to read. In another embodiment the user may access his/her unique profile through other means known in the art such as biometrics or a unique association to a particular device.

Still referring to a user's profile 503, in one embodiment the user may also be prompted to provide relevant certifications and letters of recommendation. In another embodiment, previous employers who are clients of the staffing company may be given the opportunity to review the individual and such reviews may be a part of the individual's profile. In one embodiment, the profile may include links to the potential temporary employee's social media pages, which may be provided by the employee or by the staffing company. In one illustrative embodiment, there is no charge to set up a profile on the employee side of the platform. In another illustrative embodiment, the individuals must agree to standard terms and conditions of the operation of the website in order to set up a profile.

In one exemplary embodiment, the client side 560 of the platform allows a client company 502 to create a job posting 504, describing a temporary position which it needs filled, which may include describing educational requirements, skills requirements, or requirements for a background check. This job listing may be combined with job listings from other client companies 505 to form a searchable database of jobs 506 available on the employee side of the platform, which an individual employee 501 may search in order to find temporary job positions to apply for. In one illustrative embodiment, the employee may request alerts when jobs fulfilling certain criteria are posted. These criteria may include location, area of expertise, job requirements, pay, or any other types of criteria which a job-seeker might desire.

In one embodiment the employee side 550 also has a means for the employee to apply for a job. In one embodiment, this may be as simple as clicking a button entitled apply on a specific job listing, or it may involve additional steps requesting confirmation. A particular job listing may also contain a link to a profile 508 created by the client company to give information to potential employees about the company. In one embodiment, this profile may be viewed by employees 501 even if they are not applying for a particular job in order to learn about a given client company 502.

In one illustrative embodiment, a client employer 502 will be blocked 507 from accessing an employee's profile 503 unless the employee has applied for a job 504 with that particular employer 502. Before an employee has applied for a temporary position, the employee's profile information 503 will not be accessible to the client company 502 and will not be visible on the client side 560 of the platform. Access may be blocked 507 simply by not being available for a potential employer to view. However, once an employee applies for a temporary position 504, the employee's profile information 503 will be accessible to the potential employer 502 and no longer blocked 507. After the client company reviews an employee, In one embodiment the client company 502 may then request a meeting on the platform's video conferencing/interview system 509, which may be a part of the app and/or accessible on the website.

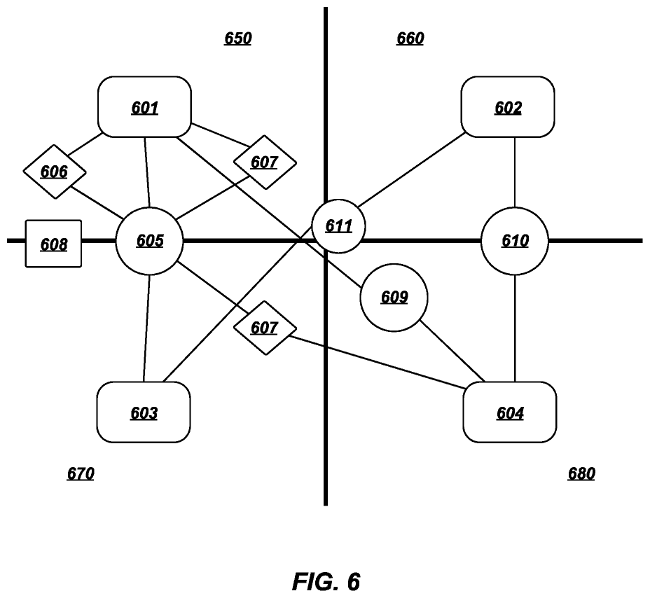

FIG. 6 shows an additional illustrative embodiment of the platform which may be used once an employee is hired. FIG. 6 shows the employee side 650 and client side 660, but also includes the portion of the platform dedicated to the staffing company 670 and finance company 680. In one embodiment, the platform has an interface 605 to allow the staffing company 603 to request information from the employee 601. This information may include both employment information 606, which may include information for a pre-employment and background check, employment eligibility information, and whatever other information is needed to finalize a formal employment contract 608, which is then entered into by the employee and the staffing company.

Still referring to FIG. 6, in one illustrative embodiment financial information is entered by the employee 601 and accessible to the staffing company 603. This financial information may include banking information for direct deposit, tax information, and all other information required to process a paycheck to the employee. In one embodiment, the final employment contract 608 is between the staffing company 603 and the employee 601, but the tax information 607 and the information necessary for processing the employee's salary 607 will be provided to the finance company 604. The final employment information 606 and the financial information 607 is only requested from the employee once the employee is hired on to a temporary position, and in one embodiment this information may be stored in a database by the staffing company 603 after an employee finishes a particular job for future use if an employee applies for another temporary position. In one embodiment, the platform may also include an area on the site 609 accessible to both the finance company 604 and the employees 601 to provide information to the employee 601 related to financial and employment issues which may include, but are not limited to employment, tax, and salary information.

The information and support about financial and employment issues may be provided by a finance company 604, which handles the employment and payment issues. In one embodiment this finance company may be a third-party company hired by the staffing company to take care of financial and employment issues. In one embodiment the finance company may provide information 609 may be on a separate platform and website which is operated by the finance company. In another embodiment, the platform may include this area even though the finance company is a separate company, and the platform may include financial tools for the finance company to perform payroll operations. In another illustrative embodiment, the finance company 604 may be the staffing company 603 or a division of the staffing company. If the finance company 604 is a division of the staffing company 603 or is the same company, the area to provide support and information on financial and employment issues 609 be provided either on the same platform or on a separate platform.

In one illustrative embodiment, the platform may also provide an interface 610 accessible to both the finance company and the client companies, wherein the finance company provides periodic invoices to the client companies 602 for the salary of each individual employee 601. The charge from the finance company to the client company may include a small markup to reflect the costs of employment. In an additional illustrative embodiment, the platform may provide an interface 611 accessible to both the client company and the staffing company whereby the staffing company can provide an invoice to the client company reflecting the cost of a subscription to the platform. In one embodiment, this cost is based on the number of hours worked by all temporary employees employed by the client company.

It will be appreciated that in one illustrative embodiment the terms “employee,” “temporary employee,” and “potential temporary employee” may be used to refer to a person who has already been hired by the staffing company for a position and who is searching for an additional temporary position after a position has ended or to add an additional temporary position to an already existing position. In such a case, the steps of performing a background check or proving eligibility to work, along with many other pre-employment steps may already have taken place, as the employee is an employee of the staffing company. In such a case, such steps do not need to be performed again, though in one embodiment a client may request an additional, or more in depth, background check. In another embodiment, the “employee,” “temporary employee,” or “potential temporary employee” may be a person who has never before held a position with the staffing company, and so the full pre-employment screening must take place upon their hire for a temporary position.

In one illustrative embodiment, limited access to employee profiles may be provided to client companies prior to an employee applying for a job position with the company, while full access to the employee's profile is only granted to a client company once the employee has applied for a position with the client company.

In the foregoing Detailed Description, various features of the disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of any single foregoing disclosed embodiment. Thus, the following claims are hereby incorporated into this Detailed Description by this reference, with each claim standing on its own as a separate embodiment of the disclosure.

It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and arrangements. Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A method of facilitating the efficient hiring of a temporary worker, said method comprising:
providing a computer based platform accessible to client companies and potential temporary employees through a network connection, provided by a centralized staffing company;
providing access to the computer based platform to client companies upon payment of a subscription fee to the centralized staffing company;
providing access to the computer based platform to potential temporary employees;
creating a profile for each potential temporary employee by providing a profile page which can be filled in with employment-relevant information by the employee;
creating a job posting for each job which a client company wishes to fill by requesting job relevant information from the client company to describe the job;
wherein at least one potential temporary employee indicates interest in a job posting by applying for the job on the platform;
providing access to the profile of each of the at least one potential temporary employee who has indicated interest in a job to the client company which posted the job through the computer based platform;
wherein the client company chooses at least one of the potential temporary employees who has indicated interest in a job posted by the client company through the computer based platform to fill the temporary position; and,
requesting required employment information from the at least one potential temporary employee chosen to fill a temporary position by the client company.

2. The method of claim 1 also comprising paying the at least one temporary employee chosen to fill a temporary position by the client company for the work done and invoicing the client company for the at least one temporary employee's pay.

3. The method of claim 2 wherein paying the at least one temporary employee chosen to fill a temporary position by the client company and invoicing the client company for the at least one temporary employee's pay is done through a third-party.

4. The method of claim 1 also comprising providing a profile page for each client company which can be completed by the client company with relevant information.

5. The method of claim 1 wherein each potential temporary employee creates a distinct username and password upon creating a profile and logs in to the platform by using the distinct username and password.

6. The method of claim 1 wherein the subscription fee is based upon the number of hours which temporary employees work for the client business.

7. A system for facilitating the efficient hiring of temporary workers, comprising:
a fee based subscription service accessible to businesses for hiring temporary employees, said service comprising a platform accessible via website or mobile application, wherein the platform includes:
an employee side wherein persons interested in temporary work can create a profile containing information they wish to be given to a client looking for temporary employees; and
a client side wherein businesses wanting to hire temporary workers can provide a job posting containing information on a temporary position that needs to be filled;
wherein the platform is operated by a temporary staffing company which hires temporary employees and handles the paperwork and paying the salary of the temporary employees while invoicing the businesses wanting to hire temporary workers for the workers' salary as well as charging a fee for the subscription service.

8. The system of claim 7 wherein the platform is operated by a temporary staffing company which hires temporary employees and handles the paperwork and paying the salary of the temporary employees while invoicing the businesses wanting to hire temporary workers for the workers' salary as well as charging a fee for the subscription service.

9. The system of claim 7 wherein the employee side provides information to the employees on jobs posted by businesses on the client side.

10. The system of claim 9 wherein an employee applies for a job on the client side.

11. The system of claim 10 wherein the system grants access to an employee's profile to a client business on the business side only upon the employee applying for a job posted by the client business.

12. The system of claim 7 also comprising a staffing company which receives a client business's request to hire an employee and performs a background check and work eligibility check on the employee.

13. The system of claim 12 also comprising a finance company which receives the employee's invoices and pays the employee while also invoicing the client company for the employee's time.

14. The system of claim 13 wherein the staffing company and the finance company are the same company.

15. The system of claim 13 wherein the staffing company and the finance company are separate companies.

16. The system of claim 7 further comprising a non-transitory computer readable medium containing in memory instruction, said instruction causing the system to execute the following steps:
access a national platform of temporary workers; and,
sourcing and recruiting individuals for temporary work being accessed via one of the following platforms; an iOS platform, an Android platform and a Windows platform.

17. A method for facilitating the efficient hiring of temporary worker, said method comprising:
A staffing company establishing a web-based platform storing employment-relevant information about potential temporary employees;
Allowing employees to establish a profile on the web-based platform containing relevant employment information;
Allowing client businesses who desire to fill temporary positions to post those positions on the platform for a fee while allowing employees to apply for those temporary positions; and,
Granting client businesses who post a job on the platform access to the profiles of those employees who applied for the temporary position.

18. The method of claim 17 also comprising:
A client business offering one of the potential temporary employees a temporary position; and
hiring a potential temporary employee as an employee of the staffing company.

19. The method of claim 18 also comprising the staffing company checking the eligibility of a potential temporary employee to work in the location where the temporary position that employee is filling is located.

20. The method of claim 18 also comprising the staffing company performing a background check on the potential temporary employee.

21. The method of claim 17 wherein the potential temporary employee is an employee of the staffing company.

22. The method of claim 17 wherein the fee is a monthly subscription fee.

23. The method of claim 17 wherein the staffing company engages a finance company, and wherein the finance company pays the employee while invoicing the client company for the employee's wages.

24. The method of claim 23 wherein the finance company is a division of the staffing company.

25. A system for the efficient hiring and retention of temporary workers, comprising:
A staffing company which provides access to a web-based platform for a monthly fee while hiring workers to fill temporary positions posted by one or more client companies;
Wherein the staffing company charges a markup only for required fees and employment taxes owed for employing a worker; and,
Wherein the staffing company derives the majority of its income from the monthly fee charged to access worker profiles and workers themselves.

26. The system of claim 25 also comprising a finance company which pays the workers hired to fill temporary positions and charges the one or more client companies for wages earned by the workers.

27. A system for providing for the efficient hiring and retention of temporary employees comprising:
a platform accessible via website or mobile application, wherein said platform comprises;
an employee side accessible to one or more individuals searching for temporary employment; and
a client company side, accessible to one or more client companies searching for individuals to fill temporary employment positions.

28. The system of claim 27 wherein the platform accessible via website or mobile application comprises code stored in a non-transitory computer medium, accessible to a computer network, which when executed causes a server to perform the steps outlined in the code to create the platform and operate the functions thereof.

29. The system of claim 27 wherein the platform is maintained by a third party staffing company not related to either the client company or the employee

30. The system of claim 29 wherein the staffing company charges a fee to the one or more client companies for access to the platform.

31. The system of claim 30 wherein the fee is charged monthly and is based upon the number of hours which temporary employees work for an individual client company.

32. The system of claim 29 wherein the one or more individuals seeking temporary employment are hired as employees of the staffing company.

33. The system of claim 29 wherein the one or more individuals seeking temporary employment are hired as employees of the staffing company upon being offered a temporary position with one or more client companies.

34. The system of claim 29 wherein the platform accessible via website or mobile application also comprises an interface between the individuals seeking temporary employment and the staffing company.

35. The system of claim 34 wherein the interface between the individuals seeking temporary employment and the staffing company allows the staffing company to request information from an individual seeking temporary employment in order to hire said individual upon that individual's selection to fill a temporary position by one of the one or more client companies.

36. The system of claim 35 wherein the information requested includes at least one of the following: proof of eligibility for employment, information to perform a background check, tax information, banking information for direct deposit, or other information required to finalize employment.

37. The system of claim 34 wherein the interface between the individuals seeking temporary employment and the staffing company includes means for entering into an employment contract.

38. The system of claim 27 wherein the employee side of the platform includes a means for a potential temporary employee to create a unique profile.

39. The system of claim 38 wherein the profile created by the potential temporary employee includes the potential temporary employee's work experience, skills, education, and any other pertinent information which the potential temporary employee would like to enter for potential employers to read.

40. The system of claim 38 wherein the profile created by the potential temporary employee includes links to the potential temporary employee's social media websites.

41. The system of claim 38 wherein the profile created by the potential temporary employee includes reviews by former employers who are client companies on the platform.

42. The system of claim 38 wherein there is no charge to set up a profile on the platform for individuals seeking temporary employment.

43. The system of claim 27 wherein the client company side allows a client company to create a job posting to describe a temporary position which it is seeking to fill.

44. The system of claim 43 wherein job listings created by one or more client companies are combined to form a searchable database of jobs which individuals seeking temporary employment can search on the employee side of the platform.

45. The system of claim 44 also comprising means for an individual seeking temporary employment to set up alerts when a job fulfilling certain criteria which the individual selects is made available.

46. The system of claim 44 also comprising a means for an individual interested in a particular job to apply for that job on the platform.

47. The system of claim 46 which allows a client company to access a profile created by an individual seeking employment only after that individual applies for a job with the client company.

48. The system of claim 27 also comprising a video chat system which allows client companies to interview individuals seeking temporary employment.

49. The system of claim 27 also comprising an interface with a staffing company.

50. The system of claim 49 wherein the interface with the staffing company allow the staffing company to request information from the individual seeking temporary employment.

51. The system of claim 50 wherein the information requested from the individual seeking temporary employment includes both employment information and financial information.

52. The system of claim 50 wherein the individual seeking temporary employment is an employee of the staffing company.

53. The system of claim 49 also comprising an interface with a finance company.

54. The system of claim 53 wherein the finance company pays the employee.

55. The system of claim 54 wherein the finance company invoices the client company for the payment made to the employee.

56. The system of claim 53 wherein the finance company is the staffing company.

57. The system of claim 53 wherein an employee is employed by the staffing company, performs work for the client company, and submits his/her hours to the staffing company, which submits the hours to the finance company; wherein the finance company pays the employee and invoices the client company for the employee's pay, while the staffing company charges the client company a subscription fee for access to the staffing company's employees.

58. A method of providing the efficient hiring and retention of temporary employees comprising:
providing a platform accessible via website or mobile application, wherein said platform comprises;
an employee side;
a client company side;
granting free access to the employee side of the platform to individuals searching for temporary employment;
providing access to the client company side of the platform for a subscription fee to client companies searching for individuals to fill temporary employment positions;
allowing client companies to post job information on the platform;
allowing individuals seeking for temporary employment to apply for jobs posted by client companies; and,
hiring an individual upon their being chosen to fill a temporary employment position.

59. The method of claim 58 also comprising retaining an employee after that employee finishes a temporary position and allowing that employee that apply for other temporary positions.

60. The method of claim 58 also comprising hiring an individual to fill more than one temporary employment position.

61. The method of claim 61 also comprising invoicing a client company for wages earned by the individual filling a temporary employment position with said client company.

62. The method of claim 61 also wherein the invoice to the client company does not include any profit for the staffing company, only required employment expenses.

63. The method of claim 61 wherein a third-party finance company is engaged to pay individuals hired to fill temporary positions and invoice client companies for their wages.

64. The method of claim 58 also comprising providing a means for individuals seeking temporary employment to create an employee profile on the employee side.

65. The method of claim 64 wherein a client company is granted limited access to an individual seeking temporary employment's profile until the individual seeking temporary employment applies for a position offered by the client company, at which point the client company is granted full access to the individual seeking temporary employment's profile.

66. The method of claim 64 wherein the platform requests employment relevant information from the individual seeking temporary employment to fill in that individual's profile.

67. The method of claim 64 also comprising providing a client company with access to the profile of an individual seeking temporary employment upon that individual seeking temporary position offered by that client company.
